(19) United States
(12) Patent Application Publication
(10) Pub. No.: US 2010/0177659 A1
(43) Pub. Date: Jul. 15, 2010

(54) METHOD AND SYSTEM FOR LOCATING INDIVIDUALS INSIDE A BUILDING

(75) Inventors: Serge Hethuin, Courbevoie (FR); Pierre-Franck Camassel, Le Chesnay (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 12/066,198

(22) PCT Filed: Sep. 6, 2006
(86) PCT No.: PCT/EP06/66175

§ 371 Date: Nov. 2, 2009

(30) Foreign Application Priority Data
Sep. 9, 2005 (FR) 05 09218

(51) Int. Cl. H04L 12/28

(52) U.S. Cl. 370/254

(57) ABSTRACT

A system and a method for locating one or more mobile objects in a detection space is disclosed. The system has a number of detection terminals (1) wherein at least the majority of the detection terminals and is equipped with an interrogating and/or answering device (2).

The invention relates notably to a method and a system for detecting and/or locating mobile objects present in a detection space, for example, inside a building, a room, etc.

It applies, notably, to the locating of persons present in buildings, or even in stores.

More generally, it applies to the detecting and/or locating of any human being.

Hereinafter in the description, the expression “mobile object” will be used to designate an individual or human being or a robot equipped with a device for exchanging signals with the rings and, where appropriate, with the other mobile objects.

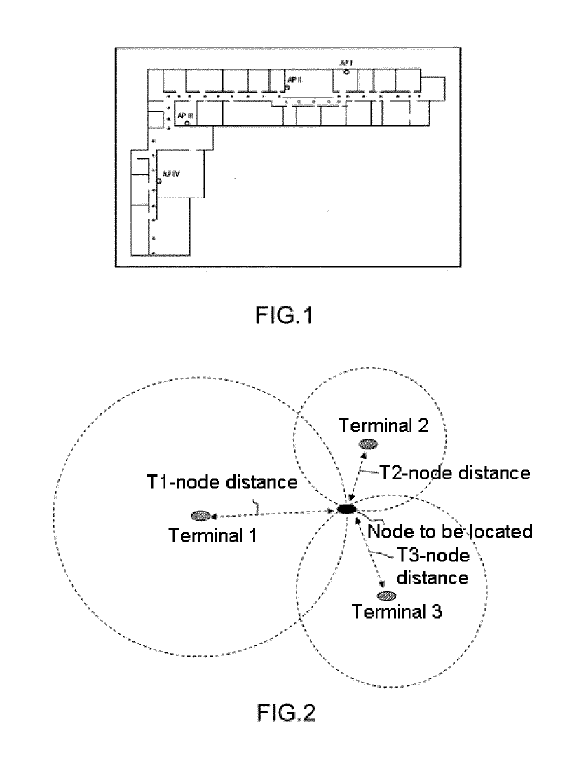

Locating individuals inside buildings relies conventionally on the existence of an infrastructure consisting of terminals, which does not come without many installation problems. For example, locating involves triangulation with position terminals; this method is known by the term ABL (Anchor-based location). An example thereof is given in FIG. 1.

One of the problems of locating inside buildings lies in the radio range in the presence of obstacles. In complicated structures like towers, the superstructure and the lift cages are elements that strongly reduce radio propagation, which means there is a need for a greater density of terminals and makes deployment significantly more complex.

To implement individual location by ABL technique according to the prior art is therefore a complex approach given the number of terminals necessary and the infrastructure to be deployed to power them and interlink them.

Another method commonly used is a method that involves independence from any infrastructure and deducing the position of the nodes by a different means. This method is known by the name AFL (Anchor-Free Location).

FIG. 2 diagrammatically represents the implementation of such a method. It consists, for example, in measuring the distances between neighboring nodes, obtaining in real time a distance matrix dᵢⱼ (distance between nodes of indices i and j) and solving all the duly obtained equations. The relative layout of all the nodes relative to each other is obtained.

We start from the assumption that the various nodes of the group are capable of measuring, by any radio technique but preferably with spread spectrum, the distance separating them from the neighbors with which they are in radio range. All the measurements made are processed in real time by a central station (one of the nodes of the group, for example). The processing mainly relies on solving M equations with N variables, with M greater than, even very much greater than, N.

The performance characteristics of the AFL method are conditioned by the total number of nodes in the group concerned and the density of these nodes. In practice, the greater the density of nodes, the greater the number of links between nodes and, consequently, the greater the location accuracy.

In some configurations (group too small, insufficient density or even excessively large obstacles thus reducing propagation between the nodes), the AFL techniques cannot operate correctly. In particular, on an attempt to enter or withdraw individuals, the results are too uncertain (insufficient accuracy, for example) or ambiguous.

The positioning of firemen or first-aiders to within 1 m in buildings is not obtained in all environment and deployment cases.

In an enclosed space (building, commercial center, tower), locating the elements of an intervention group is an increasing need in the modern world to deal with natural accidents or terrorist incidents.

The most mature locating techniques in terms of robustness involve cooperative procedures between the individuals of the group and an infrastructure (active location). It consists in the transmission, by the individuals of the group, of a wave or of information in response to the interrogation sent by an interrogating terminal of the infrastructure (ABL technique), or vice-versa.

The method and the system according to the invention make it possible in particular to overcome the drawbacks mentioned hereinabove.

The invention relates to a method for detecting and/or locating one or more mobile objects in a detection space wherein are used a network of mobile objects in a communication network, an AFL technique and measurements between the mobile objects, comprising at least the following steps:

on each or most of the mobile objects
performing distance measurements between the mobile objects present in the detection space,
using nonlinear processing to inhibit the distance measurement aberrations between two nodes over time,
linearly filtering the results of the time inhibiter,
combining all the distance information between nodes and performing the triangulation,
using nonlinear processing to reject the aberrant measurements at the output of the preceding operation,
using a linear or nonlinear path estimation filter,
on a fixed transponder in the detection space, collecting transponder position information following an interrogation of a mobile object.

It comprises, for example, a distance and angle measuring step between the mobile objects present in the detection space, a step for inhibiting distance and angle measurement aberrations between two nodes over time and a step wherein all the distance and angle information between nodes is combined and the triangulation is performed.

Detection terminals can be used as transponders.

The detection terminals are, for example, linked to a communication network.

The invention also relates to a system for detecting and/or locating one or more mobile objects in a detection space comprising a network of mobile objects in a communication network implementing the AFL technique, the system comprising at least one transponder, and each mobile object is, for example, equipped with transmitter and receiver modules adapted to operate either in interrogating mode or in answering mode, the mobile objects being able to interrogate and answer each other and are adapted to interrogate the transponders.

A mobile object can comprise:
a means adapted to perform distance or distance and angle measurements between the mobile objects present in the detection space,
a means for using nonlinear processing to inhibit the distance or distance and angle measurement aberrations between two nodes,
means adapted to linearly filter the results of the time inhibiter,
a module adapted to combine all the distance or distance and angle information between nodes and performing the triangulation,
means for using nonlinear processing to reject the aberrant measurements at the output of the combining operation,
a linear or nonlinear path estimation filter.

The transponder is, for example, a detection terminal.

The terminal can be linked to a communication network R.

A detection terminal is adapted, for example, to detect smoke and comprises, for example, a ring comprising one or more sectoral antennas (A₁, A₂, A₃, A₄), an antenna selecting device, a transmitting interrogating module and a receiving interrogating module, a management module for the interrogator linked to the network interface and an energy module, and a mobile object to be detected is, for example, equipped with a transponder.

A detection terminal comprises, for example, a ring including one or more sectoral antennas (A₁, A₂, A₃, A₄), an antenna selecting device, a transmitter module that can operate either in interrogating mode or in answering mode, and a receiver module that can operate either in interrogating mode or in answering mode, a management module for the interrogator linked to the network interface and an energy module, and the mobile object to be detected is equipped with transmitter and receiver modules operating either in interrogating mode or in answering mode, one or more antennas, energy, management, and, where appropriate, display modules.

A detection terminal may comprise a ring consisting of one or more sectoral antennas (A₁, A₂, A₃, A₄), an antenna selecting device, a transmitting-answering module and a receiving-answering module, a management module for the answerer linked to the network interface and an energy module, and the mobile object to be detected is equipped with receiving and transmitting interrogating modules.

The mobile objects are equipped, for example, with RFID transponders and the terminals are equipped with transmitting interrogating and receiving interrogating modules for interrogating the mobile objects.

The terminals can be equipped with RFID transponders and the mobile objects are equipped with transmitter and receiver modules that can operate either in interrogating mode or in answering mode, the mobile objects being able to interrogate and answer each other and also being able to interrogate the terminals equipped with RFID transponders.

A detection terminal comprises, for example, a communication and/or information storage device.

The mobile objects can be UWB radio “add-on” modules connected to cell phones (UMEX method: Uwb Mobile object EXtension) for performing radio transmissions or distance measurements with other equipment of the same type.

The mobile objects are, for example, UWB radio “add-on” modules connected to cell phones (UMEX method) for performing radio transmissions or distance measurements with other equipment of the same type or with terminals of the infrastructure.

Other characteristics and advantages of the present invention will become more apparent on reading the description that follows of an example given by way of illustration and in no way limiting, with appended figures which represent:

FIG. 1, an exemplary infrastructure consisting of a set of detection terminals,

FIG. 2, the triangulation pattern in an ABL method,

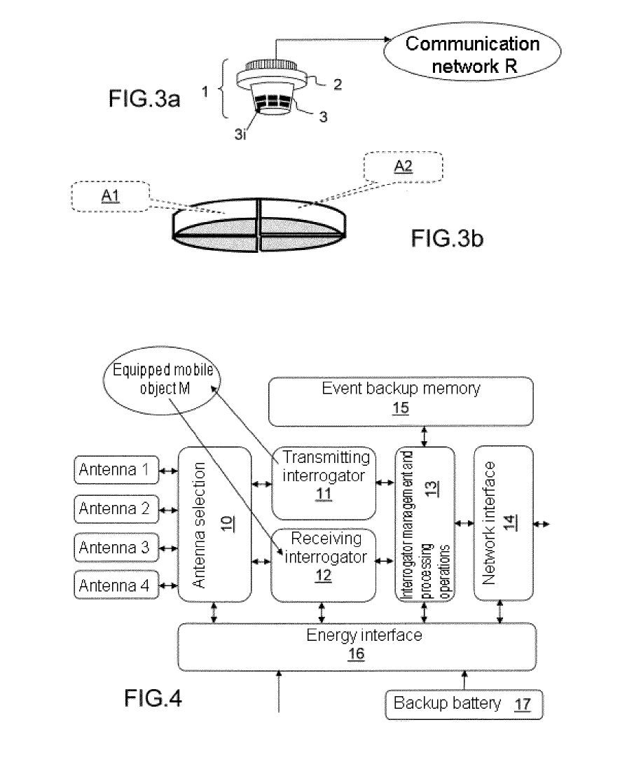

FIGS. 3a and 3b, an exemplary locating device according to the invention,

FIG. 4, a diagram according to the invention of a block diagram of an interrogating ring,

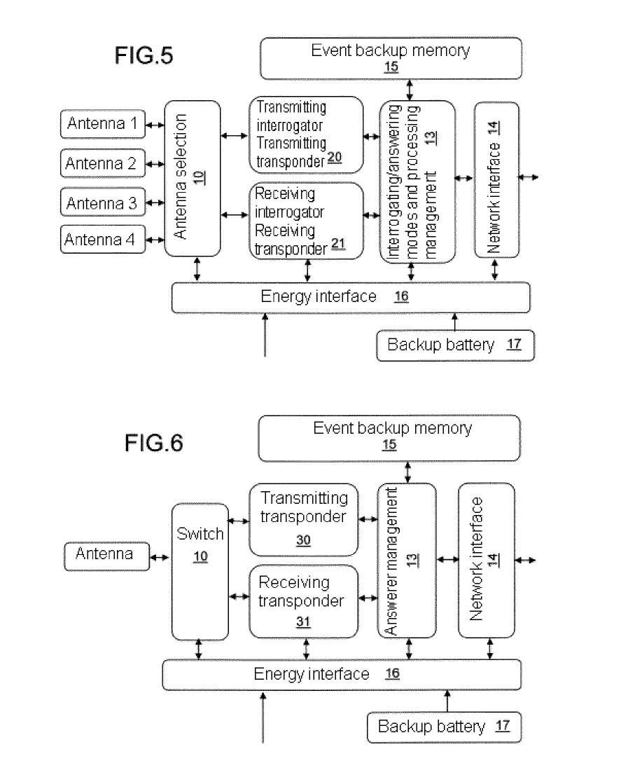

FIG. 5, a diagram according to the invention of a block diagram of an interrogating transponder/ring,

FIG. 6, a diagram according to the invention of a block diagram of a transponder ring,

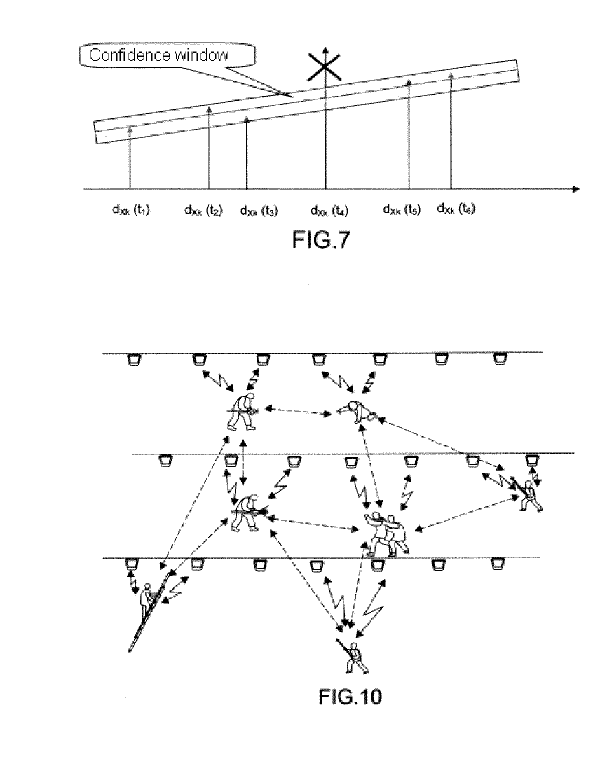

FIG. 7, a confidence window generated for data processing,

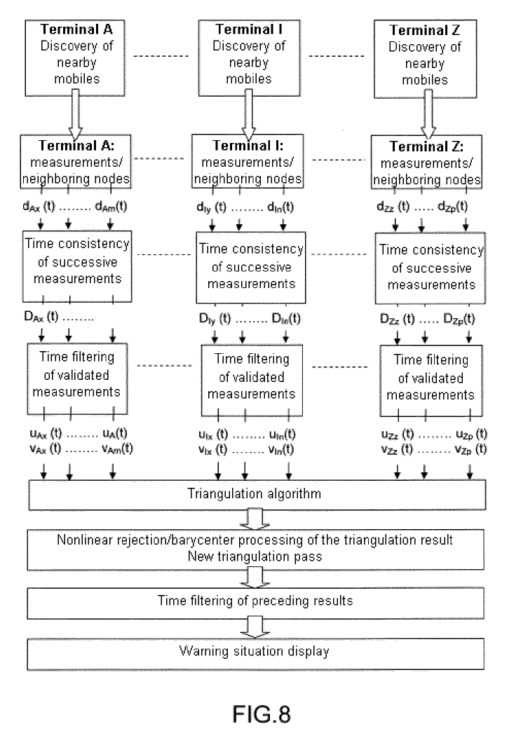

FIG. 8, an example of data processing with the ABL method,

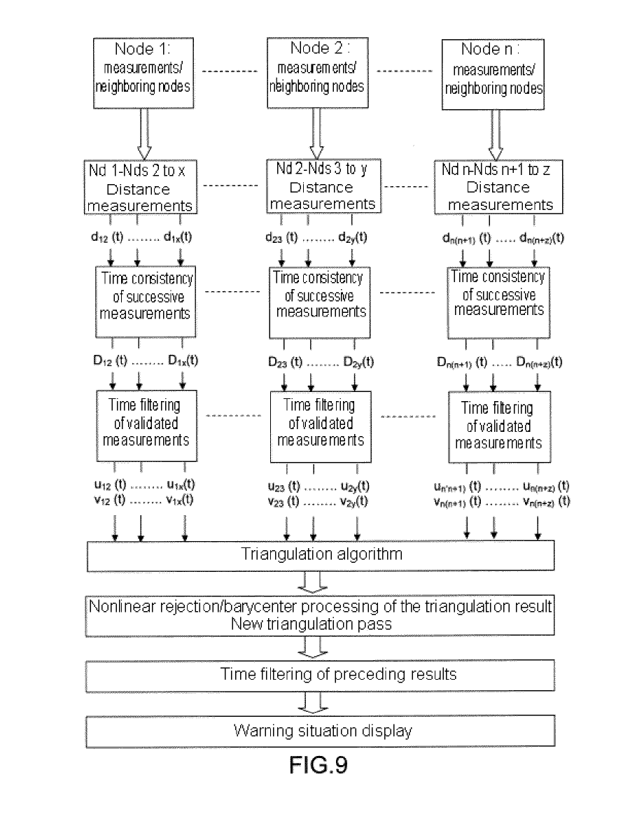

FIG. 9, an example of data processing with the AFL method,

FIG. 10, an exemplary deployment of the system according to the invention in relation to FIG. 9, and

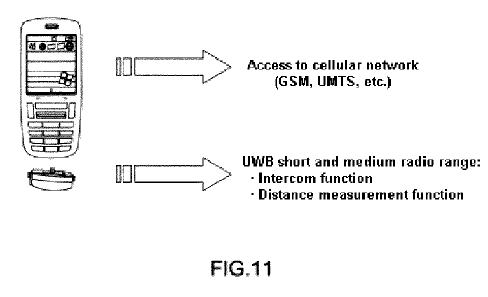

FIG. 11, an exemplary application for portables for GSM/UMTS, etc.

FIG. 3a represents an exemplary locating and detection device according to the invention. The device 1 comprises, for example, a ring 2 arranged around a detector/sprinkler 3. The ring 2 is, for example, installed on an existing structure. It can also be incorporated while the detectors/sprinklers are being manufactured. The ring 2 is offset relative to the cells 3i that have to allow water to pass or smoke to be detected in case of fire or of the start of a fire. The detector/sprinkler 3 is, for example, linked to a communication network R according to principles well known to those skilled in the art and which will not be detailed. The network makes it possible notably to link the terminals to monitoring and control devices. This example corresponds to the ABL technique.

The antenna of the ring is separated both from any flow of water and from the ceiling and from any related metallic accessories.

The ring 2 can be derived, according to the deployment types, in a number of versions, namely interrogator only, or transponder only, or interrogator-transponder. For this, it is equipped with suitable means detailed in FIGS. 4, 5 and 6.

A ring is, for example, supplied with electricity at low voltage (12/24 or 48 V). If the building has a low voltage power supply network, it is used. Otherwise, the building contains a network consisting, for example, of small diameter conductors, the necessary power being low. Another solution involves using batteries incorporated in the ring to overcome any cuts to the main electricity network (a solution that is more favorable than the transponder ring version because it is provided with a standby mode with wake-up for response triggered only on an interrogation sent by a mobile object).

FIG. 3b diagrammatically represents a ring consisting of an antenna comprising a number of sectors Aᵢ, A₁, A₂, etc. Such a structure provides, notably, for a greater selectivity of the multiple paths, possibly an angle measurement associated with the distance measurements. The benefit of such antennas is firstly that they improve the link budget and allow for longer distance measurements. The angle measurements can subsequently be analysed, complementing the distance measurements, to improve the locating accuracy.

The ring can operate as a black box, that is, it can back up the history of the latest exchanges (communications but also positioning information) after a fire. In this case, the ring is provided with a storage device in which the information backup duration is preprogrammed by the security network operator. Beyond the maximum backup duration, the information is lost (for example after 24 h).

In its “interrogator” version, diagrammatically represented in FIG. 4, the ring can be used to detect and locate individuals or mobile objects M equipped with transponders. All of these rings, interlinked, and the management module, redundant, forms the ABL system. A mobile object is equipped with matched antennas, energy modules, management and display modules not represented for reasons of simplicity.

FIG. 4 represents a block diagram of an interrogator ring comprising a number of sectoral antennas A₁, A₂, A₃, A₄. A sector is selected by means of an antenna selection device 10. A transmitting interrogating module 11 and a receiving interrogating module 12 are linked with a module 13, the function of which is to manage the interrogator and associated processing operations. The management module is linked to a network interface 14 and to an event backup memory 15. An energy interface module 16 is used to supply energy to the whole, a backup energy module 17 provides a way of overcoming a power supply problem.

In the description, the expression transmitting interrogator means: the transmission part of the interrogator, and the expression receiving interrogator designates the reception part of the interrogator. When interrogating, the first step is to transmit and then await the answer, by switching to reception mode.

The connection between a number of rings deployed to create the locating system according to the invention can be all wireless or partially wireless according to the volume of the location, therefore the number of rings installed. A partially wireless solution is based on a wired backbone, better known simply as “backbone”, for connecting to the Intranet-Internet network of the place where all the detection system is installed.

A second version of the so-called “interrogating-transponder” ring consists in allowing the possibility, in addition to the first mode in which the ring terminals are “interrogators” and the mobile objects “answerers”, to make the ring terminals function as “answerer” or transponder and the mobile objects as “interrogator”. The mobile objects represent the individuals, the robots equipped with a transmitting-receiving transponder.

FIG. 5 represents this embodiment variant. The elements already described in FIG. 4 have the same references. The equipped mobile object M is not represented for reasons of simplicity, but it is present as in FIG. 4. An interrogating-answering module 20 comprises a transmitter function and an interrogating-answering module 21 comprises a receiver function.

When the rings operate in interrogator mode (the mobile objects are then in transponder mode), a ring uses its transmitting interrogator function to interrogate a mobile object equipped with a receiver, the mobile object then using its receiving transponder function. On receipt of the interrogation signal, the mobile object switches to transmitting transponder mode in order to transmit the response to the ring which, for its part, had switched to receiving interrogator function to await the answer from the answering mobile object.

If the rings operate in transponder mode (interrogator mode for the mobile objects), the ring is basically in receiving transponder function. It awaits an interrogation from a mobile object then using the transmitting interrogator function. Immediately it receives the interrogation from the mobile object, the ring switches to transmitting transponder function to transmit the response to the mobile object which, for its part, had switched to receiving interrogator function to await the answer from the transponder.

In transponder mode, the ring retransmits, on interrogation from a mobile object equipped with the interrogator, its identity, its location (according to a pre-established reference) and other available information (sector having made the detection, and so on). In interrogator mode on the ring, the mobile object returns an answer consisting of its identity and available additional information (mission to be carried out, objective to be reached, etc.).

The interrogator system—either the ring in interrogator mode associated with the mobile object in transponder mode, or the mobile object in interrogator mode associated with the ring in transponder mode—has to deduce from this a distance measurement between it and the transponder, that is, in all cases, the distance between the ring and the mobile object. Thus, therefore, this measurement is available on the mobile object when the mobile object is in interrogator mode and the ring is in transponder mode. This measurement is available on the ring when the ring is in interrogator mode and the mobile object is in transponder mode. It transmits this information to the central or off-site system which is responsible for taking account of all the measurements (e.g. all the measurements between a mobile object and all the rings in its radio range) and performing the triangulation and, if necessary, retransmits to the mobile objects the positioning information. The two modes (interrogator ring/transponder mobile object on the one hand and transponder ring/interrogator mobile object on the other hand) are exclusive but possible on the same hardware structure of the ring. The modes are triggered either by a “central intelligence” or are preprogrammed.

A third so-called “transponder” version represented in FIG. 6 consists in providing the ring only with the electronics for the “transponder” mode. This version is linked with a mobile object M as described in FIG. 4. These electronics are then considerably reduced, as is the cost. The transponder is continually in receiving transponder function 31 (even on standby, the consumption then being extremely reduced) and switches to transmitting transponder function 30 only to send an answer following the receipt of an interrogation from a mobile object equipped with an interrogator device.

The device can even be more economic if operating without transmission, only in backscatter mode as exists in the radiofrequency identification devices (RFIDs). There is no network interface (no network interface obligation). In this case, there is no longer a transmitter, the device according to the invention returns an overmodulation on the RF energy received following an interrogation (obtained either from the ring if the interrogator is on the ring, or from the mobile object in the reverse case) (like microwave badges). Of course, by eliminating the transmitter, the system consumes only very little. However, the range is reduced; the link budget is 1/R⁴ instead of 1/R².

A fourth version is that enabling the mobile objects to be both in interrogator mode and in transponder mode according to their requirements for distance measurements between them (between the mobile objects as in the AFL method). The mobile objects can be cell phones for example. The particular feature of this version is that it enables the mobile objects, in addition to the AFL locating method, to interrogate rings equipped simply with RFID “transponders” (FIG. 10 for example).

The set of these rings forms the enhanced AFL system. The infrastructure to be installed between the rings is reduced to nothing at all (the ring is simply placed around the detector/sprinkler).

The communication and locating module, being placed at height, can be used to obtain the best possible radio range.

In the case of an installation on detectors/sprinklers, the distance between the latter being limited to 6 m according to international safety regulations, the radio coverage is excellent and the nodes to be located are covered redundantly.

The description hereinabove presents two systems which are complementary and which address two different needs. The ABL system provides locating accuracy, a networking of the information, and delivers a situation awareness generated centrally at the place to be protected. The application potential is maximized (centralized log, use of this new medium for other purposes, and so on).

The enhanced AFL system is an essentially mobile device (see FIG. 10 describing an application for firemen for example). The basic technique used is that of AFL, but since it is also possible for the mobile objects to interrogate the rings (passive transponder in RFID technique), the problems inherent to AFL no longer exist (greater problem of mobile object density, numbers of mobile objects, and so on). It supports locating intelligence, handles situation awareness without requiring centralization, provides networking capability thanks to the interrogators carried by the intervention group. The equipment cost for the emergency services is of course greater initially, but the equipment cost for buildings/sites/towers/trade centers to be protected is minimized.

Depending on the policy of the town and the number of places to be protected, the appropriate response will be the first or the second system.

The method according to the invention implements certain data processing steps described, for example, in relation to FIGS. 7 to 9.

FIG. 7 diagrammatically represents a confidence window used in the method.

FIG. 8 shows different stages having in particular the following functions:
The first stage consists in identifying the mobile objects within the radio range of each terminal.
The second stage consists in performing the distance (or angle) measurements between each terminal and the mobile objects present within its radio coverage.
The third stage consists in inhibiting the measurement aberrations, between two nodes, over time, using a specific technique suited to the nonlinear context of the aberrations.

Take the various measurements over time between a terminal X and a mobile object k within its radio range: d_{Xk}(t₁)d_{Xk}(t₂)d_{Xk}(t₃) . . . d_{Xk}(tₙ) . . . , the basic principle of time consistency processing is based on the rejection of samples that are not compatible with an acceptable variation. This means having to consider the speed and maximum acceleration of the mobile object and to take into account any direct path losses.

Thus, in the following example, the samples are retained as long as they are within the confidence window, represented in FIG. 7. This window is constructed according to criteria deriving from the calculation of the speed and of the acceptable path variations for the mobile object.
The fourth stage consists in linearly filtering the results of the preceding time consistency detector. The outputs are both distances that are validated time-wise and with estimation of their speed of movement.
The fifth stage consists in combining all the information and performing the triangulation.
The sixth stage consists, using the redundancy in the measurements, in rejecting the measurements that are too distant from the barycenter, itself determined based on all the measurements (nonlinear processing).
The seventh stage consists in using a path estimation filter to filter the successive results obtained over time at the output of the preceding stage (sixth stage).

FIG. 8 concerns distance measurements between nodes which can be extended to angle measurements.

FIG. 9 represents the steps implemented when using the AFL technique. The associated FIG. 10 diagrammatically represents by broken lines the interrogator-answerer interchanges between mobile objects and by solid lines the complementary interchanges between mobile objects and RFID transponders on the ring.

The steps implemented for the AFL technique are identical to the steps described in relation to FIG. 8, apart from the first step.

The system according to the invention is applicable to numerous applications, some of which are given hereinbelow for illustration purposes, but not exhaustively.

### Fire Detection

Coupling a smoke or fire detector/water sprinkler makes it possible to recover this information on the communication-location system.

The ABL communication system can be used to convey this information to a central collection system but recover it also on the firemen (mobile objects) so that they know the point where the fire started if the nodes are provided with these communication means.

### Guiding Firefighting Forces to the Epicenter

Recovery of the fire detection information enables the fire-fighting forces to know the critical point of intervention and accordingly devise a strategy for attacking the fire (ABL).

### Locating Fire-Prevention Operatives

Altogether, the modules implement a modified ABL technique, taking account of the overabundance of terminals.

### Sensor Network System

The set of detectors provided with the ABL module constitutes a network of wirelessly-interconnected sensors. These various sensors, in addition to measuring the ambient temperature, can be provided with presence detection modules thus making it possible to add to the number of known parameters of the situation.

This knowledge makes it possible to generate a complete report: scale of the fires at the various points, number and position of the means and resources, so leading to knowledge of the optimal fire-fighting or catastrophe strategies.

This situation awareness, already known at a central point of the fire or catastrophe fighting device, can be transmitted to each of the people involved, via a wrist unit, or projected by collimation onto the fireman's visor.

### Radio-Guidance for Firefighters

At the same time, with the communication and display means available to the nodes on the firemen, it is possible to radioguide the latter to particular points according to an overall strategy.

### Optimizing Firefighting Means

By this same strategy, it is possible to optimize the resources to be implemented by dosing, for example, the actions of the sprinklers (volume and type of mist to be applied, limiting of the water volumes if not necessary, and so on) thanks to the ABL technique network.

### Extension to Communication Applications for Firefighting Forces

Over and above the locating of the firefighters or first-aiders, it is possible to provide the same people with a function for communicating with each other or with the infrastructure according to the invention with the ABL technique to reach the staging area.

This goes beyond the terminal intercommunication means, to transmit step by step the location results from each of them but also to enable voice or data interchanges by this radio channel.

### Extension to Third Party Applications (Maintenance and Logistics Teams, Company Personnel, Etc.)

In as much as the radio means for locating make it possible to convey voice, data and possibly video wireless transmissions, it becomes possible to use the wireless network not only to locate firemen, emergency doctors, but also to:
locate maintenance operatives and cleaners, throughout the day,
radio transmissions between these same operatives or even for the personnel of a company.

Thus, the wireless network becomes useful in the daily life of the occupants of a company building and becomes assigned as a priority to the deployment of the intervention forces in the event of fire or serious problems.

### Installation of Portable Solutions for GSM/UMTS/802.16e, Etc.

It is also possible, by extension, to complement this approach by providing the people involved or third parties (people working in the buildings, maintenance teams, etc.) with “add-on” modules on their cell phones (UMEX method: Uwb Mobile object Extension).

FIG. 11 shows the conventional cell phone, with an “add-on” module comprising the UWB radio for performing:
radio transmissions with other equipment of the same type or with access points (detector terminals) fixed to the ceiling or to the walls.
distance measurements with other mobile object equipment of the same type (ranging) or with detector terminals placed on the ceiling or on the walls.

This “add-on” module can ultimately be incorporated directly in the cell phone.

1-16. (canceled)

17. A method for detecting and/or locating one or more mobile objects in a detection space using a network of mobile objects in a communication network, an AFL technique and measurement between the mobile objects, wherein it comprises at least the following steps:
on each or most of the mobile objects
performing distance measurements between the mobile objects present in the detection space,
on one of the mobile objects or terminals that recover all the distance information
using nonlinear processing to inhibit the distance measurement aberrations between two nodes or mobile objects over time,
linearly filtering the results of the time inhibiter,
combining all the distance information between mobile objects and performing the triangulation,
using nonlinear processing to reject the aberrant measurements at the output of the preceding operation,
using a linear or nonlinear path estimation filter, on a detection terminal equipped with an interrogating and/or answering device that is fixed in the detection space, collecting calculated position information.

18. The method as claimed in claim 17, comprising a distance and angle measuring step between the mobile objects present in the detection space, a step for inhibiting distance and angle measurement aberrations between two nodes over time and a step wherein all the distance and angle information between nodes is combined and the triangulation is performed.

19. The method as claimed in claim 17, wherein detection terminals are used as transponders.

20. The method as claimed in claim 19, wherein said detection terminals are linked to a communication network.

21. A system for detecting and/or locating one or more mobile objects in a detection space comprising a network of mobile objects in a communication network implementing the AFL technique, wherein the system comprises at least one detection terminal equipped with an interrogating and/or answering device, and in that each mobile object is equipped with transmitter and receiver modules adapted to operate either in interrogating mode or in answering mode, the mobile objects being able to interrogate and answer each other and are adapted to interrogate the detection terminals equipped with an interrogating and/or answering device and wherein a mobile object comprises:
a means adapted to perform distance or distance and angle measurements between the mobile objects present in the detection space,
a means for using nonlinear processing to inhibit the distance or distance and angle measurement aberrations between two nodes,
means adapted to linearly filter the results of the time inhibiter,
a module adapted to combine all the distance or distance and angle information between nodes and performing the triangulation,
means for using nonlinear processing to reject the aberrant measurements at the output of the combining operation,
a linear or nonlinear path estimation filter.

22. The system as claimed in claim 20, wherein the transponder is a detection terminal.

23. The system as claimed in claim 22, wherein the terminal is linked to a communication network R.

24. The system as claimed in claim 22, wherein a detection terminal is adapted to detect smoke and in that it includes a ring comprising one or more sectoral antennas (A₁, A₂, A₃, A₄), an antenna selecting device, a transmitting interrogating module and a receiving interrogating module, a management module for the interrogator linked to the network interface and an energy module, and in that a mobile object to be detected is equipped with a transponder.

25. The system as claimed in claim 23, wherein a detection terminal is adapted to detect smoke and in that it includes a ring comprising one or more sectoral antennas (A₁, A₂, A₃, A₄), an antenna selecting device, a transmitting interrogating module and a receiving interrogating module and a receiving interrogating module, a management module for the interrogator linked to the network interface and an energy module, and in that a mobile object to be detected is equipped with a transponder.

26. The system as claimed in claim 22, wherein a detection terminal includes a ring comprising one or more sectoral antennas (A₁, A₂, A₃, A₄), an antenna selecting device, a transmitter module that can operate either in interrogating mode or in answering mode, and a receiver module that can operate either in interrogating mode or in answering mode, a management module for that interrogator linked to the network interface and an energy module, and in that the mobile object to be detected is equipped with transmitter and receiver module operating either in interrogating mode or in answering mode, one or more antennas, energy, management, and, where appropriate, display modules.

27. The system as claimed in claim 23, wherein a detection terminal includes a ring comprising one or more sectoral antennas (A₁, A₂, A₃, A₄), an antenna selecting device, a transmitter module that can operate either in interrogating mode or in answering mode, and a receiver module that can operate either in interrogating mode or in answering mode, a management module for the interrogator linked to the network interface and an energy module, and in that the mobile object to be detected is equipped with transmitter and receiver modules operating either in interrogating mode or in answering mode, one or more antennas, energy, management, and, where appropriate, display modules.

28. The system as claimed in claim 22, wherein a detection terminal includes a ring comprising one or more sectoral antennas (A₁, A₂, A₃, A₄), an antenna selecting device, a transmitting-answering module and a receiving-answering module, a management module for the answered linked to the network interface and an energy module, and in that the mobile object to be detected is equipped with receiving and transmitting interrogating modules.

29. The system as claimed in claim 23, wherein a detection terminal includes a ring comprising one or more sectoral antennas (A₁, A₂, A₃, A₄), an antenna selecting device, a transmitting-answering module and a receiving-answering module, a management module for the answerer linked to the network interface and an energy module, and in that the mobile object to be detected is equipped with receiving and transmitting interrogating modules.

30. The system as claimed in claim 20, wherein the mobile objects are equipped with RFID transponders and the terminals are equipped with transmitting interrogating and receiving interrogating modules for interrogating the mobile objects.

31. The system as claimed in claim 22, wherein the terminals are equipped with RFID transponders and the mobile objects are equipped with transmitter and receiver modules that can operate either in interrogating mode or in answering mode, the mobile objects being able to interrogate and answer each other and also being able to interrogate the terminals equipped with RFID transponders.

32. The system as claimed in claim 23, wherein the terminals are equipped with RFID transponders and the mobile objects are equipped with transmitter and receiver modules that can operate either in interrogating mode or in answering mode, the mobile objects being able to interrogate and answer each other and also being able to interrogate the terminals equipped with RFID transponders.

33. The system as claimed in claim 20, wherein a detection terminal comprises a communication and/or information storage device.

34. The system as claimed in claim 20, wherein the mobile objects are UWB radio add-on modules connected to cell phones (UMEX method: Uwb Mobile object Extension) for performing radio transmissions or distance measurements with other equipment of the same type.

35. The system as claimed in claim 20, wherein the mobile objects are UWB radio add-on modules connected to cell phones (UMEX method) for performing radio transmissions or distance measurements with other equipment of the same type or with terminals of the infrastructure.
